(19) United States
(12) Patent Application Publication
(10) Pub. No.: US 2026/0257321 A1
(43) Pub. Date: Sep. 3, 2026

(54) VARIABLE-ANGLE OFFSET SPINDLE SCREWDRIVER

(71) Applicant: SHANGHAI HOTO TECHNOLOGY CO., LTD., Shanghai (CN)

(72) Inventors: Wenxuan Zhang, Shanghai (CN); Dongsheng Lu, Shanghai (CN)

(21) Appl. No.: 19/551,580

(22) Filed: Feb. 26, 2026

(30) Foreign Application Priority Data
Feb. 28, 2025 (CN) 202520356084.6

(51) Int. Cl. B25B 21/00; B25B 23/00; B25F 5/00; B25F 5/02

(52) U.S. Cl. CPC B25B 21/00; B25B 23/0028; B25F 5/001; B25F 5/02

(57) ABSTRACT

The present disclosure relates to a variable-angle offset spindle screwdriver, and more particularly to the technical field of screwdrivers. The variable-angle offset spindle screwdriver includes: a driving assembly, an output bit, a rotating mechanism, and an offset transmission assembly, wherein an input end of the rotating mechanism is in driving engagement with an output shaft of the driving assembly, an output end of the rotating mechanism is in driving engagement with the offset transmission assembly, and the output bit is drivingly connected to the offset transmission assembly.

### CROSS-REFERENCE TO THE ERELATED APPLICATIONS

The present disclosure claims priority to Chinese Patent Application No. 2025203560846, filed with the China National Intellectual Property Administration on February 28, 2025, and entitled “VARIABLE-ANGLE OFFSET SPINDLE SCREWDRIVER”, the contents of which are incorporated herein by reference in entirety.

### TECHNICAL FIELD

The present disclosure relates to the field of screwdrivers, and in particular, to a variable-angle offset spindle screwdriver.

### BACKGROUND ART

A screwdriver is a common operating tool in daily life. The output shaft of an existing screwdriver is generally located at an axis position, and is collinear with the output bit. When facing assembly requirements in narrow spaces or unusual positions, it may be blocked, resulting in limited operation, which not only affects operational efficiency but may also fail to fully rotate the screw into place during operation, leading to safety incidents.

### SUMMARY

An objective of the embodiments of the present disclosure is to provide a variable-angle offset spindle screwdriver, which is used for solving the above technical problems.

An embodiment of the present disclosure provides a variable-angle offset spindle screwdriver, which includes: a driving assembly, an output bit, a rotating mechanism, and an offset transmission assembly, wherein an input end of the rotating mechanism is in driving engagement with an output shaft of the driving assembly, an output end of the rotating mechanism is in driving engagement with the offset transmission assembly, and the output bit is drivingly connected to the offset transmission assembly; the offset transmission assembly is configured to adjust a distance between the output bit and the output shaft of the driving assembly, such that the output bit is offset to a periphery of the output shaft of the driving assembly; and the rotating mechanism is configured to adjust an included angle between the output bit and the output shaft of the driving assembly.

Optionally, the offset transmission assembly includes a fixed housing, an input spindle and an output spindle are arranged on the fixed housing in parallel and spaced apart from each other, the input spindle and the output spindle are provided with transmission gears in meshing engagement with each other, the output shaft of the driving assembly is connected to the input spindle, and the output bit is connected to the output spindle.

Optionally, the rotating mechanism includes a protective housing, a first bevel gear, a second bevel gear, and a third bevel gear; a mounting shaft is arranged inside the protective housing; the output shaft of the driving assembly and the output bit are both perpendicular to the mounting shaft; the first bevel gear is arranged on the output shaft of the driving assembly; the second bevel gear is arranged on the mounting shaft, the third bevel gear is drivingly connected to the first transmission gear; the first bevel gear, the second bevel gear, and the third bevel gear are in sequential meshing engagement; an adjustment opening is formed in the protective housing; the offset transmission assembly extends into an interior of the protective housing through the adjustment opening; the input spindle is fixedly connected to the third bevel gear; and the third bevel gear is rotatable circumferentially about the mounting shaft, to cause the offset transmission assembly and the output bit to rotate along the adjustment opening, thereby adjusting the included angle between the output bit and the output shaft of the driving assembly.

Optionally, the fixed housing is provided with an annular rotating portion, a rotating groove is formed in the protective housing, and the rotating portion is engaged in the rotating groove.

Optionally, the rotating mechanism further includes a locking mechanism, the locking mechanism includes a positioning latch, a plurality of locking grooves are circumferentially arranged on the rotating portion at intervals, the positioning latch has a locking position where the positioning latch is engaged in one of the locking grooves and an unlocking position where the positioning latch is disengaged from the locking grooves, and the positioning latch is drivable to switch between the locking position and the unlocking position.

Optionally, a switching button is arranged on the protective housing, the switching button is drivingly connected to the positioning latch, and is configured to drive the positioning latch.

Optionally, an elastic member is arranged on the mounting shaft, the elastic member is connected to the positioning latch, and the elastic member is configured to drive the positioning latch to reset to the locking position.

Optionally, a dust shield is arranged over the adjustment opening, and the dust shield is configured to shield the adjustment opening.

Optionally, the protective housing includes a first housing part and a second housing part arranged symmetrically, fixed screw holes are formed in the first housing part and the second housing part, studs are inserted through the fixed screw holes, and the first housing part and the second housing part are detachably connected via the studs.

Optionally, the driving assembly includes a driving motor and a reduction gearbox, and a rotor shaft of the driving motor is drivingly connected to the offset transmission assembly via the reduction gearbox.

The present disclosure provides a variable-angle offset spindle screwdriver, which includes a driving assembly, an output bit, a rotating mechanism, and an offset transmission assembly. The output bit can be mounted via the offset transmission assembly, such that the output bit is offset from the driving assembly, and the included angle between the output bit and the output shaft of the driving assembly can be adjusted in cooperation with the rotating mechanism, thereby allowing the output bit to extend into narrow gaps to satisfy operational requirements in special environments, and improving the practicability of the variable-angle offset spindle screwdriver.

### BRIEF DESCRIPTION OF DRAWINGS

To more clearly illustrate the technical solutions of the embodiments of the present disclosure, the drawings used in the embodiments will be briefly described below. It should be understood that the drawings only show some embodiments of the present disclosure, and therefore should not be regarded as limiting the scope. For those of ordinary skill in the art, other relevant drawings may be obtained based on these drawings without inventive effort.

FIG. 1 is a sectional view of an offset transmission assembly in a variable-angle offset spindle screwdriver provided by an embodiment of the present disclosure;

FIG. 2 is a usage state diagram of a screwdriver in the prior art;

FIG. 3 is a usage state diagram of the variable-angle offset spindle screwdriver provided by an embodiment of the present disclosure;

FIG. 4 is another usage state diagram of the variable-angle offset spindle screwdriver provided by an embodiment of the present disclosure; and

FIG. 5 is an exploded view of the variable-angle offset spindle screwdriver provided by an embodiment of the present disclosure.

Reference numerals: 100, output bit; 200, offset transmission assembly; 201, fixed housing; 202, input spindle; 203, output spindle; 204, transmission gear; 300, rotating mechanism; 301, protective housing; 302, first bevel gear; 303, second bevel gear; 304, third bevel gear; 305, mounting shaft; 3011, adjustment opening; 2011, rotating portion; 3012, rotating groove; 400, locking mechanism; 401, positioning latch; 402, locking groove; 403, switching button; 404, elastic member; 500, dust shield; 3013, first housing part; 3014, second housing part; 3015, stud; 600, driving motor; 700, reduction gearbox.

### DETAILED DESCRIPTION OF EMBODIMENTS

To make the objectives, technical solutions, and advantages of the embodiments of the present disclosure clearer, the technical solutions in the embodiments of the present disclosure will be described clearly and completely below with reference to the drawings in the embodiments of the present disclosure. Obviously, the described embodiments are only part of the embodiments of the present disclosure, rather than all embodiments. Generally, components of the embodiments of the present disclosure described and illustrated in the drawings herein may be arranged and designed in various different configurations.

In the description of the present disclosure, it should be noted that the orientation or positional relationships indicated by terms such as "inner" and "outer" are based on the orientation or positional relationships shown in the accompanying drawings, or the orientation or positional relationships that the product of the present disclosure is usually placed in when used, and are only for the convenience of describing the present disclosure and simplifying the description, rather than indicating or implying that the device or element referred to must have a specific orientation, be constructed and operated in a specific orientation, and thus cannot be construed as limiting the present disclosure. Furthermore, terms such as "first", "second", etc., are used only for distinguishing description and should not be construed as indicating or implying relative importance.

In the description of the present disclosure, it should also be noted that, unless otherwise specified and limited, the terms "arranged" and "connected" should be interpreted broadly. For example, a connection may be a fixed connection, a detachable connection, or an integral connections; it may be a direct connection, or may be an indirect connection through an intermediate medium, and may be an internal communication between two elements. For those of ordinary skill in the art, the specific meanings of the above-mentioned terms in the present disclosure can be understood based on specific circumstances.

An embodiment of the present disclosure provides a variable-angle offset spindle screwdriver, which includes: a driving assembly, an output bit 100, and an offset transmission assembly 200; wherein the offset transmission assembly 200 includes a fixed housing 201, an input spindle 202 and an output spindle 203 are arranged on the fixed housing 201 in parallel and spaced apart from each other, the input spindle 202 and the output spindle 203 are provided with transmission gears 204 in meshing engagement with each other, an output shaft of the driving assembly is connected to the input spindle 202, the output bit 100 is connected to the output spindle 203, and the offset transmission assembly 200 is configured to adjust a distance between the output bit 100 and the output shaft of the driving assembly, such that the output bit 100 is offset to a periphery of the output shaft of the driving assembly.

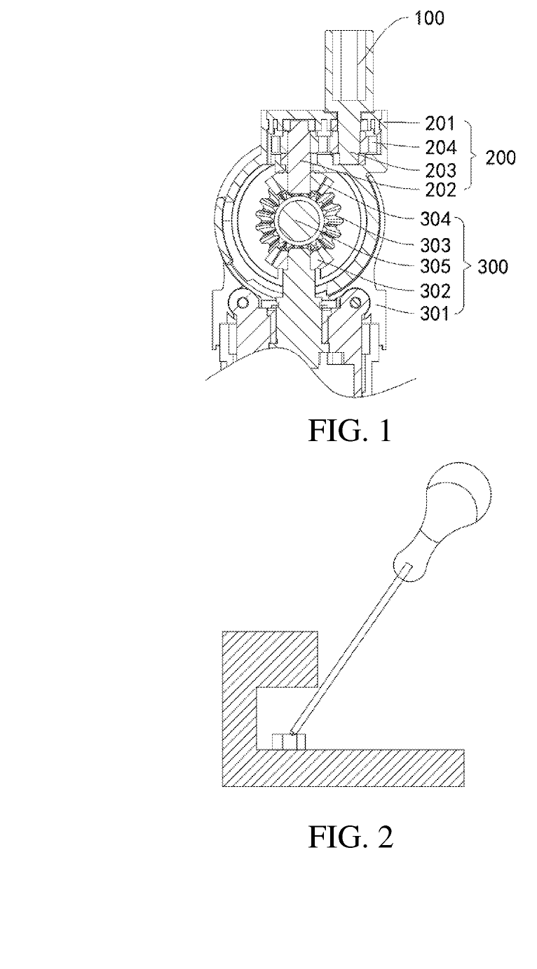

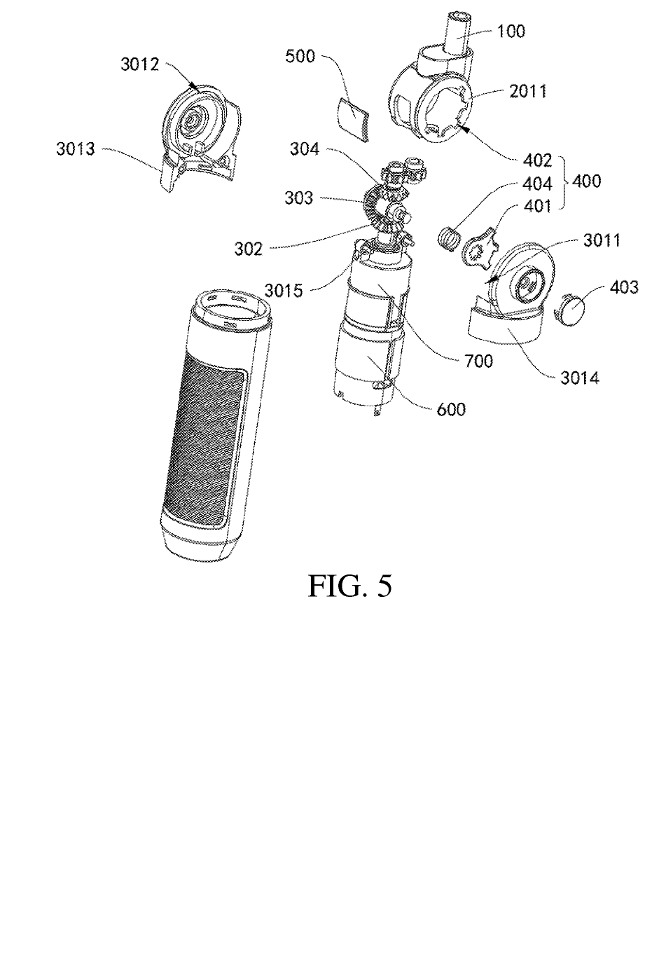

Referring to FIGS. 1 and 5, the driving assembly can be a manual or electric driving tool, which is configured to drive the output bit 100 to rotate to perform rotational operations on parts such as bolts and nuts. Referring to FIG. 2, in the related art, the output shaft of the driving assembly is usually directly connected to the output bit 100, and the output bit 100 is collinear with the output shaft of the driving assembly. This may cause such screwdrivers to be unable to complete operations or be inconvenient to operate in some narrow spaces or when operating on parts at certain corners. In this embodiment, the output bit 100 is mounted via the offset transmission assembly 200, such that the output bit 100 is offset from the output shaft of the driving assembly on the premise of ensuring that the driving assembly normally drives the output bit 100 to rotate. The offset output bit 100 can more easily extend into narrow spaces for operation, solving the problem of inconvenient operation in special environments. Specifically, the offset transmission assembly 200 includes a fixed housing 201, and an input spindle 202 and an output spindle 203 that are arranged on the fixed housing 201 in parallel and spaced apart from each other, the input spindle 202 is connected to the output shaft of the driving assembly, and the output spindle 203 is connected to the output bit 100, achieving separation and offset between the bit and the driving assembly. The input spindle 202 and the output spindle 203 are respectively provided with transmission gears 204, and the transmission gears 204 mesh with each other, thereby transmitting the power of the driving assembly to the output bit 100 to cause the output bit 100 to rotate for installing or disassembling screws. By mounting the output bit 100 via the offset transmission assembly 200, the output bit 100 is offset from the driving assembly, thereby adapting to operational requirements in special environments and improving the practicability of the variable-angle offset spindle screwdriver.

Alternatively, in some possible embodiments, the driving assembly includes a rotating mechanism 300, the output shaft of the driving assembly is in driving engagement with the first transmission gear 204 of the offset transmission assembly 200 via the rotating mechanism 300, and the rotating mechanism 300 is configured to adjust an included angle between the output bit 100 and the output shaft of the driving assembly.

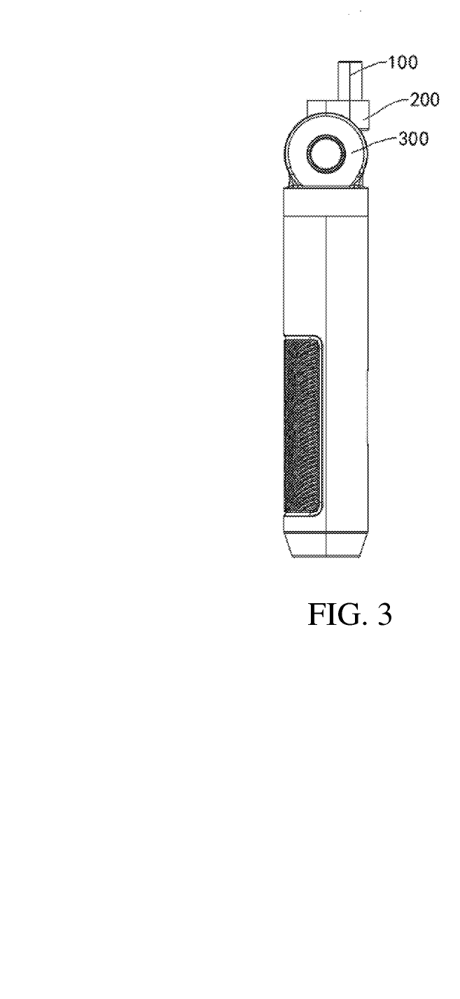

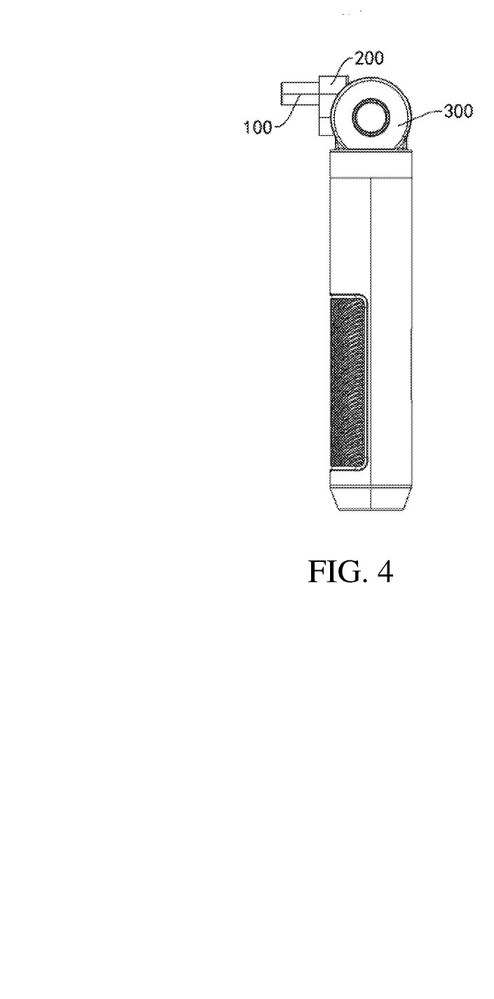

Referring to FIGS. 3 and 4, the rotating mechanism 300 rotates synchronously with the output bit 100, and the included angle between the output bit 100 and the output shaft of the driving assembly can be adjusted by rotating the rotating mechanism 300. It can be understood that when performing screw rotation operations in some special operating spaces, a long straight screwdriver may not be able to complete the operation or may be difficult to operate. For example, when operating in a narrow or obstructed space, a straight-handle screwdriver is inconvenient or unable to complete the operation. In such cases, an L-shaped screwdriver is more convenient. The variable-angle offset spindle screwdriver provided in this embodiment can not only offset the output bit 100 via the offset transmission assembly 200 but also adjust the angle of the output bit 100 via the rotating mechanism 300. Their mutual cooperation enables adaptation to diverse and complex environments, thereby satisfying operational needs in various environments.

Optionally, in some possible embodiments, the rotating mechanism 300 includes a protective housing 301, a first bevel gear 302, a second bevel gear 303, and a third bevel gear 304; a mounting shaft 305 is arranged inside the protective housing 301; the output shaft of the driving assembly and the output bit 100 are both perpendicular to the mounting shaft 305; the first bevel gear 302 is arranged on the output shaft of the driving assembly; the second bevel gear 303 is arranged on the mounting shaft 305; the third bevel gear 304 is drivingly connected to the first transmission gear 204; the first bevel gear 302, the second bevel gear 303, and the third bevel gear 304 are in sequential meshing engagement; an adjustment opening 3011 is formed in the protective housing 301; the offset transmission assembly 200 extends into an interior of the protective housing 301 through the adjustment opening 3011; the input spindle 202 is fixedly connected to the third bevel gear 304, and the third bevel gear 304 is rotatable circumferentially about the mounting shaft 305, to cause the offset transmission assembly 200 and the output bit 100 to rotate along the adjustment opening 3011, thereby adjusting the included angle between the output bit 100 and the output shaft of the driving assembly.

Referring to FIG. 5, the protective housing can not only serve an encapsulation function, forming a relatively closed environment, thereby protecting the gear transmission structure. At the same time, the protective housing can further form a mounting bracket, supporting structures such as the mounting shaft 305 and limiting the gears, ensuring the stability during gear transmission and the smoothness during the rotational adjustment of the third bevel gear 304, preventing the gears from falling off or being damaged by external impact, and preventing external foreign objects from jamming into the gears during maintenance, which would affect normal gear transmission. The first bevel gear 302, the second bevel gear 303, and the third bevel gear 304 are in sequential meshing engagement to form a gear transmission mechanism, ensuring that the driving assembly can drive the output bit 100 to rotate. At the same time, the second bevel gear 303 is fixed on the mounting shaft 305, and the third bevel gear 304 can rotate circumferentially about the mounting shaft 305 while in meshing engagement with the second bevel gear 303, thereby driving the offset transmission assembly connected to the third bevel gear 304 to rotate. An adjustment opening 3011 is formed on one side of the protective housing 301. On the one hand, this facilitates the extension of the offset transmission assembly 200 to the outside of the protective housing 301, thereby connecting the output bit 100. On the other hand, the adjustment opening 3011 is of a strip structure, forming an adjustment chute, which ensures the smooth rotation of the offset transmission assembly 200 while playing a limiting role, preventing damage to the output bit 100 due to an excessive rotation angle. The adjustment angle of the output bit 100, the opening size, and the actual length of the adjustment opening 3011 are selected during production according to the actual required adjustment angle, and are not limited in this embodiment. FIGS. 3 and 4 only show one embodiment where the output bit 100 rotates 90 degrees. In other embodiments, the output bit 100 may also rotate 180 degrees (90 degrees on each side) or 270 degrees, etc.

Optionally, in some possible embodiments, the fixed housing 201 has an annular rotating portion 2011, a rotating groove 3012 is formed in the protective housing 301, and the rotating portion 2011 is engaged in the rotating groove 3012.

Referring to FIG. 5, the protective housing 301 is provided with an annular rotating groove 3012, the fixed housing 201 is correspondingly provided with an annular rotating portion 2011, the rotating portion 2011 is engaged in the rotating groove 3012, thereby rotationally connecting the protective housing 301 and the fixed housing 201, such that the offset transmission assembly 200 and the driving assembly form an integrated structure. The rotating groove 3012 and the rotating portion 2011 cooperate with each other to play a limiting role, ensuring the stability of the offset transmission assembly 200 during the rotational adjustment.

Optionally, in some possible embodiments, the rotating mechanism 300 further includes a locking mechanism 400, the locking mechanism 400 includes a positioning latch 401, a plurality of locking grooves 402 are circumferentially arranged on the rotating portion 2011 at intervals, the positioning latch 401 has a locking position where the positioning latch 401 is engaged in one of the locking grooves 402 and an unlocking position where the positioning latch 401 is disengaged from the locking grooves 402, and the positioning latch 401 is drivable to switch between the locking position and the unlocking position.

Referring to FIG. 5, the positioning latch 401 is slidably arranged on the mounting shaft 305, a plurality of locking grooves 402 are circumferentially arranged on the rotating portion 2011 at intervals, the spacing angles between the locking grooves 402 are equal, corresponding to the rotation angles of the output bit 100, such that the output bit 100 can be fixed at specific angles, such as 30, 60, or 90 degrees. The positioning latch 401 has a protruding part matching the shape and size of the locking grooves 402. When the protruding part of the positioning latch 401 is engaged in one of the locking grooves 402, the rotating portion 2011 cannot rotate freely, thereby keeping the output bit 100 at a fixed angle. Conversely, when the positioning latch 401 is disengaged from the locking grooves 402, the rotating portion 2011 can rotate freely, thereby adjusting the angle of the output bit 100. An operator may drive the positioning latch 401 to switch between the locking position and the unlocking position, thereby fixing the output bit 100 during use, preventing the angle of the output bit 100 from being uncontrolled and rotating arbitrarily during operation, which would affect the operational effect.

Optionally, in some possible embodiments, a switching button 403 is arranged on the protective housing 301, the switching button 403 is drivingly connected to the positioning latch 401, and the switching button 403 is configured to drive the positioning latch 401. An elastic member 404 is arranged on the mounting shaft 305, the elastic member 404 is connected to the positioning latch 401, and the elastic member 404 is configured to drive the positioning latch 401 to reset to the locking position.

Referring to FIG. 5, the switching button 403 and the elastic member 404 are respectively arranged on two sides of the positioning latch 401. In an initial state, the positioning latch 401 is in the locking position. When it is necessary to adjust the angle of the output bit 100, the switching button 403 is pressed to disengage the positioning latch 401 from the locking grooves 402. At this time, the output bit 100 is unlocked and can be rotated freely. When the output bit 100 is rotated to a suitable angle and the switching button 403 is released, under the elastic force of the elastic member 404, the positioning latch 401 resets to the locking position, thereby locking the angle of the output bit 100 and ensuring the stability of the output bit 100 during subsequent operations. During the screw rotation operation, the positioning latch 401 is always maintained in the locking position under the action of the elastic member 404, preventing the output bit 100 from rotating, without requiring the operator to continuously press the switching button 403, ensuring the convenience and stability of the operation process.

Optionally, in some possible embodiments, a dust shield 500 is arranged over the adjustment opening 3011, and the dust shield 500 is configured to shield the adjustment opening 3011.

Referring to FIG. 5, the dust shield is slidably arranged between the protective housing and the fixed housing 201, the fixed housing 201 has a protruding structure, the protruding structure can abut against the dust shield 500, when adjusting the angle of the output bit 100, the fixed housing 201 can drive the dust shield 500 to rotate along the adjustment opening 3011, thereby covering the adjustment opening 3011 exposed due to the rotation of the offset transmission assembly 200, preventing external foreign objects from entering the interior to damage the gear structure, and ensuring the service life of the variable-angle offset spindle screwdriver.

Optionally, in some possible embodiments, the protective housing 301 includes a first housing part 3013 and a second housing part 3014 arranged symmetrically, fixed screw holes are formed in the first housing part 3013 and the second housing part 3014, studs 3015 are inserted through the fixed screw holes, and the first housing part 3013 and the second housing part 3014 are detachably connected via the studs 3015.

The protective housing 301 includes a first housing part 3013 and a second housing part 3014 arranged symmetrically. The first housing part 3013 and the second housing part 3014 can be processed separately, which can reduce production difficulty and facilitate the installation of structures such as the first bevel gear 302, the second bevel gear 303, the third bevel gear 304, and the locking mechanism 400. The first housing part 3013 and the second housing part 3014 are fixed by the studs 3015, ensuring connection strength. In addition to protecting the internal structure, the protective housing 301 can further limit and support the output bit 100 and the rotating mechanism 300, playing a reinforcing role, thereby achieving higher torque output.

Optionally, in some possible embodiments, the driving assembly includes a driving motor 600 and a reduction gearbox 700, and a rotor shaft of the driving motor 600 is drivingly connected to the offset transmission assembly 200 via the reduction gearbox 700. Driving the output bit 100 via the driving motor 600 and the reduction gearbox 700 improves operational efficiency and precision, and ensures stability during screw installation.

It should be noted that, in the absence of conflict, the features in the embodiments of the present disclosure may be combined with each other.

The above are only preferred embodiments of the present disclosure and are not intended to limit the present disclosure. For those skilled in the art, the present disclosure may have various modifications and variations. Any modifications, equivalent substitutions, improvements, etc., made within the spirit and principles of the present disclosure shall fall within the protection scope of the present disclosure.

1. A variable-angle offset spindle screwdriver, comprising: a driving assembly, an output bit, a rotating mechanism, and an offset transmission assembly, wherein an input end of the rotating mechanism is in driving engagement with an output shaft of the driving assembly, an output end of the rotating mechanism is in driving engagement with the offset transmission assembly, and the output bit is drivingly connected to the offset transmission assembly; the offset transmission assembly is configured to adjust a distance between the output bit and the output shaft of the driving assembly, such that the output bit is offset to a periphery of the output shaft of the driving assembly; and the rotating mechanism is configured to adjust an included angle between the output bit and the output shaft of the driving assembly.

2. The variable-angle offset spindle screwdriver according to claim 1, wherein the offset transmission assembly comprises a fixed housing, an input spindle and an output spindle are arranged on the fixed housing in parallel and spaced apart from each other, the input spindle and the output spindle are provided with transmission gears in meshing engagement with each other, the output shaft of the driving assembly is connected to the input spindle, and the output bit is connected to the output spindle.

3. The variable-angle offset spindle screwdriver according to claim 2, wherein the rotating mechanism comprises a protective housing, a first bevel gear, a second bevel gear, and a third bevel gear, a mounting shaft is arranged inside the protective housing, the output shaft of the driving assembly and the output bit are both perpendicular to the mounting shaft, the first bevel gear is arranged on the output shaft of the driving assembly, the second bevel gear is arranged on the mounting shaft, the third bevel gear is drivingly connected to the transmission gear, the first bevel gear, the second bevel gear, and the third bevel gear are in sequential meshing engagement, an adjustment opening is formed in the protective housing, the offset transmission assembly extends into an interior of the protective housing through the adjustment opening, the input spindle is fixedly connected to the third bevel gear, and the third bevel gear is rotatable circumferentially about the mounting shaft, to cause the offset transmission assembly and the output bit to rotate along the adjustment opening, thereby adjusting the included angle between the output bit and the output shaft of the driving assembly.

4. The variable-angle offset spindle screwdriver according to claim 3, wherein the fixed housing has an annular rotating portion, a rotating groove is formed in the protective housing, and the rotating portion is engaged in the rotating groove.

5. The variable-angle offset spindle screwdriver according to claim 4, wherein the rotating mechanism further comprises a locking mechanism, the locking mechanism comprises a positioning latch, a plurality of locking grooves are circumferentially arranged on the rotating portion at intervals, the positioning latch has a locking position where the positioning latch is engaged in one of the locking grooves and an unlocking position where the positioning latch is disengaged from the locking grooves, and the positioning latch is drivable to switch between the locking position and the unlocking position.

6. The variable-angle offset spindle screwdriver according to claim 5, wherein a switching button is arranged on the protective housing, the switching button is drivingly connected to the positioning latch, and the switching button is configured to drive the positioning latch.

7. The variable-angle offset spindle screwdriver according to claim 5, wherein an elastic member is arranged on the mounting shaft, the elastic member is connected to the positioning latch, and the elastic member is configured to drive the positioning latch to reset to the locking position.

8. The variable-angle offset spindle screwdriver according to claim 3, wherein a dust shield is arranged over the adjustment opening, and the dust shield is configured to shield the adjustment opening.

9. The variable-angle offset spindle screwdriver according to claim 3, wherein the protective housing comprises a first housing part and a second housing part arranged symmetrically, fixed screw holes are formed in the first housing part and the second housing part, studs are inserted through the fixed screw holes, and the first housing part and the second housing part are detachably connected via the studs.

10. The variable-angle offset spindle screwdriver according to claim 1, wherein the driving assembly comprises a driving motor and a reduction gearbox, and a rotor shaft of the driving motor is drivingly connected to the offset transmission assembly via the reduction gearbox.
